(19) United States
(12) Patent Application Publication
(10) Pub. No.: US 2026/0010768 A1
(43) Pub. Date: Jan. 8, 2026

(54) EFFICIENT AUTOREGRESSIVE GENERATION USING REINFORCEMENT LEARNING

(71) Applicant: QUALCOMM Incorporated, San Diego, CA (US)

(72) Inventors: Amélie Marie Estelle ROYER, Amsterdam (NL); Babak EHTESHAMI BEJNORDI, Amsterdam (NL)

(21) Appl. No.: 18/761,861

(22) Filed: Jul. 2, 2024

(51) Int. Cl. G06N 3/0475; G06F 40/284; G06F 40/40; G06N 3/045; G06N 3/092

(52) U.S. Cl. CPC G06N 3/0475; G06F 40/284; G06F 40/40; G06N 3/045; G06N 3/092

(57) ABSTRACT

Certain aspects of the present disclosure provide techniques and apparatus for machine learning. In an example method, a first output generated by a first language model, of a plurality of language models, based on an input prompt is accessed. A second language model is selected, from the plurality of language models, to generate a second output for the input prompt based on processing the first output using a reinforcement learning (RL) agent. Generation of a response to the input prompt is facilitated based on the first output and the second output, comprising causing the first output to be provided as input to the second language model.

### INTRODUCTION

Aspects of the present disclosure relate to generative machine learning.

A wide variety of machine learning model architectures have been developed to perform a variety of tasks, including generation of data such as text, images, video, audio, and the like, entity classification or detection, value or probability regression, and many others. Many language models trained to generate natural language output (e.g., large language models (LLMs)) generate sentences in an autoregressive manner (e.g., token by token). While state-of-the-art language models can produce accurate and detailed output, generating long sentences becomes extremely computationally expensive. For example, if the target sentence has N tokens, generating the output may involve N calls to the language model.

### BRIEF SUMMARY

Certain aspects of the present disclosure provide a processor-implemented method, comprising: accessing a first output generated by a first language model, of a plurality of language models, based on an input prompt; selecting, from the plurality of language models, a second language model to generate a second output for the input prompt based on processing the first output using a reinforcement learning (RL) agent; and facilitating generation of a response to the input prompt based on the first output and the second output, comprising causing the first output to be provided as input to the second language model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for improved generative machine learning, according to some aspects of the present disclosure.

FIG. 2 depicts an example workflow for dynamic language model selection using reinforcement learning, according to some aspects of the present disclosure.

FIG. 3A depicts an example architecture for attention-guided language generation, according to some aspects of the present disclosure.

FIG. 3B depicts an example architecture for attention-guided language model selection, according to some aspects of the present disclosure.

FIG. 4 is a flow diagram depicting an example method for dynamic language model selection and generative machine learning, according to some aspects of the present disclosure.

FIG. 5 is a flow diagram depicting an example method for generative machine learning, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved generative machine learning. Specifically, in some aspects of the present disclosure, reinforcement learning is used to drive dynamic model selection in order to reduce computational expense of generative machine learning.

In many generative models, as discussed above, output is generated token-by-token. However, in many cases, not all tokens in the output are equally difficult to predict. For example, some tokens may be relatively easy to predict, such as connecting words, the end of a word, a portion of a common idiom, and the like. Using large language models to generate such “easy” tokens may incur substantial computational expense that need not be consumed. In some aspects therefore, it may be desirable to use more efficient (e.g., less computationally expensive) language models for such “easy” tokens. Further, some tasks and inputs may be readily handled by small models, obviating use of an (expensive) large model entirely.

However, determining whether a token is sufficiently “easy” in advance may be an extremely difficult task. For example, the output probabilities of the language model are not reliably predictors of the “easiness” of the token, as these probabilities are generally poorly calibrated for such a task. In aspects of the present disclosure, reinforcement learning is leveraged to train an agent that balances autoregressive generation efficiency with output accuracy to select which language model, of a set of language models, should be used to generate each token in the output. In some aspects, the agent can incorporate constraints to restrict the model switching in some cases, which may improve output stability, reduce expense, and/or improve model deployment on computationally limited devices (e.g., smartphones).

In some aspects, given a set of language models (LMs) with varying efficiency and/or accuracy (e.g., ranging from large models that are computationally expensive but highly accurate, to smaller models that are computationally efficient but less reliable), a reinforcement learning (RL) agent can select which LM should be used for each subsequent token based on inputs such as one or more of the previously generated tokens. The RL agent may be trained to optimize or at least improve a variety of targets, such as performance (e.g., output accuracy) while also reducing computational expense, improving ease of deployment, and the like. For example, the RL agent may be trained to minimize (or at least reduce) the total running costs of generating output (e.g., the computational cost of executing the selected set of LMs). In some aspects, the RL agent may be constrained to reduce the number of model switches (e.g., to use the same LM for at least X consecutive tokens) to reduce the overhead of loading and offloading the models to and from memory. In some aspects the RL agent may be constrained to select an LM that is equal to or smaller than (e.g., less computationally expensive) the LM selected for the previous token (e.g., for tasks where token generation generally becomes easier as the output length increases).

Generally, aspects of the present disclosure provide substantially improved generative machine learning through dynamically reduced computational expense with sustained model performance.

### Example Workflow for Improved Generative Machine Learning

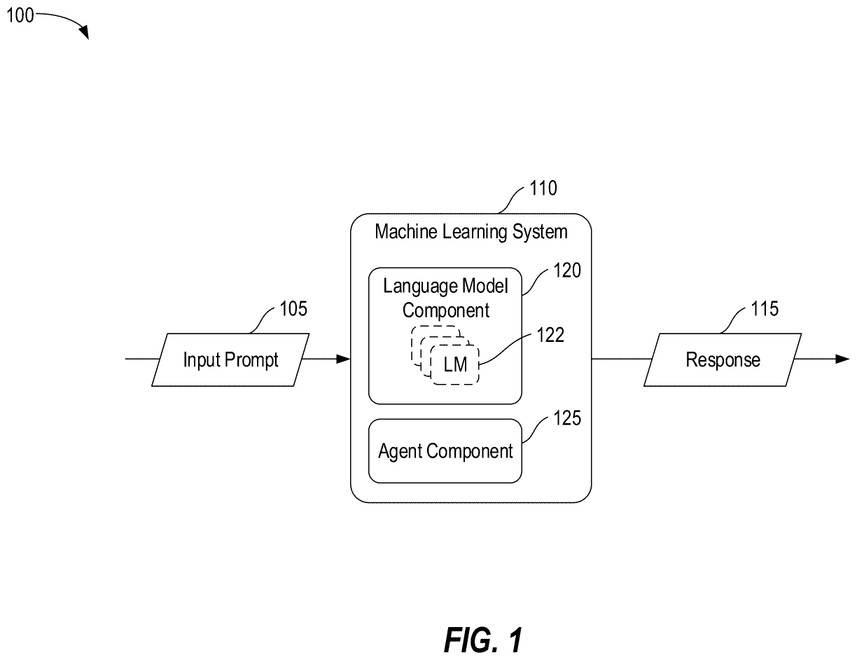

FIG. 1 depicts an example workflow 100 for improved generative machine learning, according to some aspects of the present disclosure.

In the illustrated workflow 100, an input prompt 105 is accessed by a machine learning system 110 to generate a response 115. As used herein, “accessing” data may generally include receiving, retrieving, requesting, generating, collecting, obtaining, or otherwise gaining access to the data. For example, the input prompt 105 may be received as input from a user or other application. The input prompt 105 and the response 115 each generally comprise a sequence of tokens (e.g., words, characters, phrases, and the like). For example, the input prompt 105 and the response 115 may each comprise natural language text. In some aspects, as used herein, a “token” refers to a portion of text, including a word, a part of a word (e.g., “por” and “tion” from the word “portion”), a single character, a set of words, and the like.

Although illustrated as a discrete system for conceptual clarity, in some aspects, the operations of the machine learning system 110 may be combined or distributed across any number of systems, and may be implemented using hardware, software, or a combination of hardware and software. In the illustrated example, the machine learning system 110 includes a language model component (which itself includes a set of language models (LMs) 122) and an agent component 125. Although depicted as discrete components for conceptual clarity, in some aspects, the operations of the depicted components (and others not illustrated) may be combined or distributed across any number of components.

In the illustrated workflow 100, the language model component 120 is used to process the input prompt 105 using one or more LMs 122 to generate the response 115. In some aspects, as discussed above, the response 115 is generated token-by-token. For example, the language model component 120 may generate a first token based on the input prompt 105 using an LM 122, a second token in the response 115 based on the input prompt 105 and the first token using the same or a different LM 122, and so on.

In the illustrated example, the language model component 120 comprises or uses at least two trained LMs 122. Generally, the set of LMs 122 used by the language model component 120 may be instantiated or trained using a variety of different techniques. For example, in some aspects, each LM 122 may be trained separately with different architectures (e.g., using a different number of parameters), different hyperparameters, different tasks, and the like. In some aspects, a first LM (designated L) may be trained, and one or more the remaining LMs 122 of the set may correspond to truncated versions of the first LM. For example, a second LM (designated L;) may correspond to the first LM L truncated at layer N−i, where N is the number of layers in the first model L. That is, after a base LM 122 is trained, each other LM 122 of the set may be generated by removing one or more layers (e.g., the final layer(s)) of the base LM 122. In some aspects, use of truncated models allows the agent component 125 to effectively learn early-exiting strategies for token generation.

As another example, in some aspects, one of the LMs 122 may be a model having a relatively large number of parameters (e.g., an LLM) while one or more other LMs 122 are smaller models (e.g., having fewer parameters and referred to in some aspects as “draft models” or “small language models” (SLMs)). In some aspects, this arrangement can allow the agent component 125 to generalize speculative decoding, optimizing (or at least improving) the switch(es) between the LLM(s) and the SLM(s).

As another example, in some aspects, a base model (e.g., an LLM) may be trained, and one or more of the LMs 122 may correspond to finetuned versions of the base model. For example, one or more LMs 122 may correspond to the base model combined with one or more finetuned adapters (e.g., low-rank adapters (LoRAs)). In some aspects, the adapters of the LMs 122 may be finetuned for different specialized tasks, allowing the agent component 125 to learn to switch between tasks when generating the response 115 based on the conversation topic(s).

In some aspects, the agent component 125 may comprise or use RL-based techniques to select which LM 122 should be used to generate each token of the response 115. In some aspects, the agent component 125 receives, as input, the current output of the previously used LM 122 (e.g., the selected token, the token probabilities (e.g., the output probabilities for each token of a set of tokens), and the like). In some aspects, as discussed in more detail below, the agent component 125 may additionally or alternatively evaluate other data, such as intermediate feature tensor(s) from one or more layers within the previously used LM 122. In some aspects, the agent component 125 may further process an indication of the previously selected LM 122 and/or the sequence of LMs 122 that have been selected thus far.

As discussed below in more detail, the agent component 125 may process this input data to generate a selection of the next LM 122, from the set of LMs 122, to be used to generate the next token in the response 115. In some aspects, as discussed above, the agent component 125 may determine to use the same LM 122 that generated the current token, or may select a different LM 122 dynamically. Using reinforcement learning, the agent component 125 generally learns optimal (or at least improved) switching techniques and generates improved responses 115 using fewer computational resources.

For example, in some aspects, the dynamic model switching on a per-token basis can substantially improve the quality of the output responses 115, as compared to some conventional techniques that select a single model (from a set of models) to generate the entire output (e.g., all output tokens) based on the input prompt. This per-response model selection becomes increasingly inefficient and/or inaccurate for longer prompts and/or responses, as these systems tend to rely on selecting the more computationally expensive models more than preferred. As another example, the dynamic switching aspects described herein can be substantially more efficient and more accurate than some conventional speculative decoding implementations. Generally, speculative decoding uses a relatively deterministic switching pattern with strict rejection sampling. For example, an SLM may be used to generate some number of tokens, and an LLM may be used to approve or reject the SLM-generated tokens. Any tokens rejected by the LLM correspond to wasted computational expense (as the SLM output is not used for these tokens). In contrast, using reinforcement learning, the agent component 125 may learn to refrain from switching to the SLM after learning which output(s) are likely to be rejected by the LLM. This results in improved output with substantially reduced expense.

Generally, aspects of the present disclosure can be applied to improve any task involving or relying on generative machine learning (e.g., text generation). For example, in autonomous driving applications, some aspects of the present disclosure can enable the orchestration of the generation of text using one or more models (e.g., LLMs with high computational expense) on the cloud or on another remote server or device, as well as using one or more smaller language models on device (e.g., on a smartphone or by the autonomous vehicle itself). As one example, the RL agent may ensure that local model(s) are used to process routine tasks such as navigation instructions, weather updates, and music requests, while off-device (larger) models are used to process more complex reasoning and/or context-aware decision-making tasks.

As another example, in computer program code generation tasks, some aspects of the present disclosure can enable efficient on-device code generation, error detection, documentation writing, and the like on relatively limited devices (e.g., laptop platforms). As yet another example, in the context of artificial intelligence (AI) assistants, some aspects of the present disclosure can empower significantly improved AI assistance on mobile phones or other limited devices. For example, the AI assistance can leverage large (computationally expensive) models on the cloud, as well as smaller and/or more specialized local models for various domains (e.g., translation, personal messages, health information, and the like).

### Example Workflow for Dynamic Language Model Selection Using Reinforcement Learning

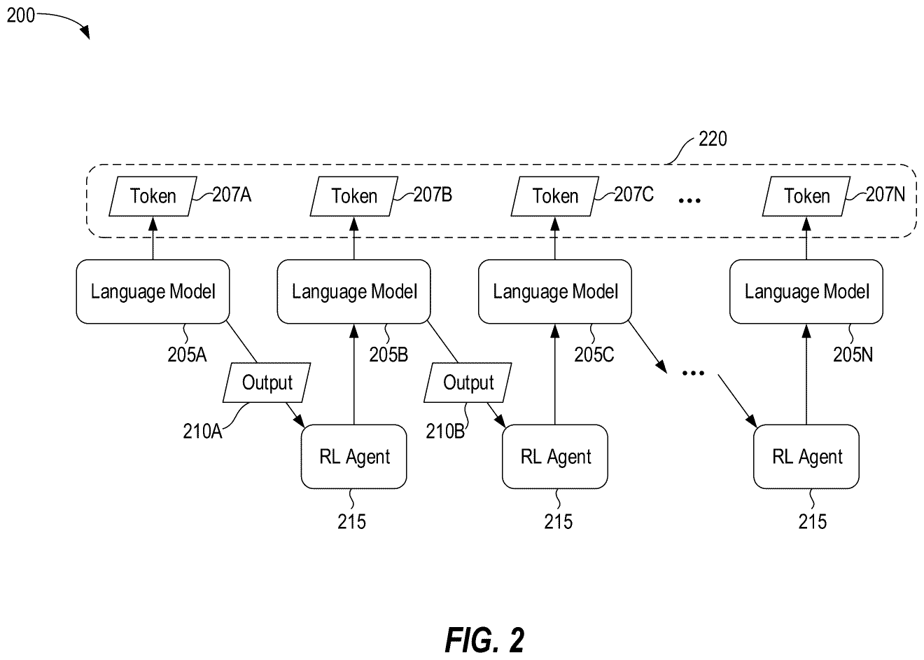

FIG. 2 depicts an example workflow 200 for dynamic language model selection using reinforcement learning, according to some aspects of the present disclosure. In some aspects, the workflow 200 is performed by a machine learning system, such as the machine learning system 110 of FIG. 1.

In the illustrated workflow 200, a set of language models 205A-N (which may correspond to the LMs 122 of FIG. 1) are used to generate a response 220 (which may correspond to the response 115 of FIG. 1). Further, the language model 205 used to generate each token 207 of the response 220 is selected by an RL agent 215 (which may correspond to the agent component 125 of FIG. 1).

Specifically, in the illustrated example, a first language model 205A is used to generate a first token 207A (e.g., based on an input prompt, such as the input prompt 105 of FIG. 1). As illustrated, an output 210A from the language model 205A is also processed by the RL agent 215. As discussed above, the output 210A may generally correspond to the generated token 207A itself, the output probabilities of the language model 205A (e.g., the probability of generating the token 207A and/or one or more other tokens), one or more intermediate features from the language model 205A, and the like. Although not depicted in the illustrated example, in some aspects, the RL agent 215 may further receive data such as an indication of the language model 205A used to generate the token 207A, one or more previous language models 205 used to generate prior tokens 207, the input prompt, and the like.

As discussed above, the RL agent 215 generally corresponds to an agent trained using reinforcement learning to select which language model 205 should be used to generate each token 207 of the response 220. For example, as illustrated, the RL agent 215 may process the output 210A and select the language model 205B for the next output. Although the illustrated example depicts the RL agent 215 switching from the language model 205A to the language model 205B, as discussed above, the RL agent 215 may determine to use the same language model 205A to generate the next token.

As illustrated, the language model 205B is then used to generate the next token 207B of the response 220. Although not illustrated in the workflow 200, the language model 205B may process a variety of data to generate the token 207B, such as the output 210A from the prior language model 205A, the token 207A from the prior language model 205A, the input prompt, and the like.

In the workflow 200, in addition to generating the token 207B, the output 210B from the language model 205B is accessed by the RL agent 215. As discussed above, the RL agent 215 may process this output 210B (which may include, for example, the token 207B, the output probabilities generated by the language model 205B, one or more intermediate features from the language model 205B when generating the token 207B, the input prompt, an indication of the language model 205B used and/or the prior language model 205A, and the like) to select a next language model 205C. As discussed above, although the illustrated example depicts the RL agent 215 switching from the language model 205B to the language model 205C, the RL agent 215 may determine to use the same language model 205B to generate the next token.

As illustrated, the language model 205C is then used to generate the next token 207C of the response 220. Although not illustrated in the workflow 200, as discussed above, the language model 205C may process a variety of data to generate the token 207C, such as the output 210B from the prior language model 205B, the token 207B from the prior language model 205B, the token 207A from the language model 205A, the input prompt, and the like.

As illustrated by the ellipses, this process may be repeated any number of times until the RL agent 215 selects the language model 205N, which is used to generate the final token 207N of the response 220. In this way, the RL agent 215 can dynamically switch which language model 205 will be used to generate each token 207 of the response 220, allowing the computational expense of generating the response 220 to be reduced (e.g., switching between language models 205 with differing numbers of parameters) and/or allowing the accuracy or relevance of the response 220 to be improved (e.g., switching between language models 205 with different specialties).

### Example Architectures for Attention-Guided Generative Machine Learning

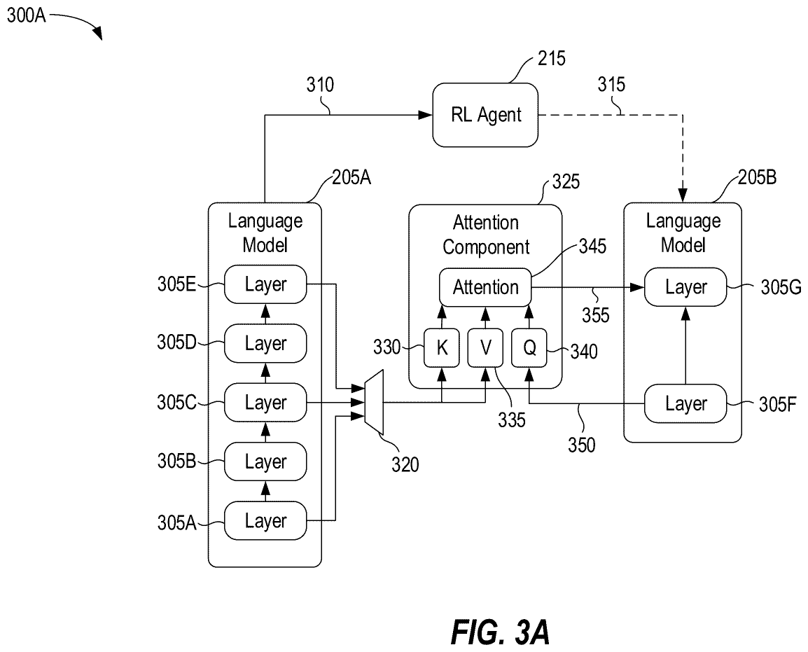

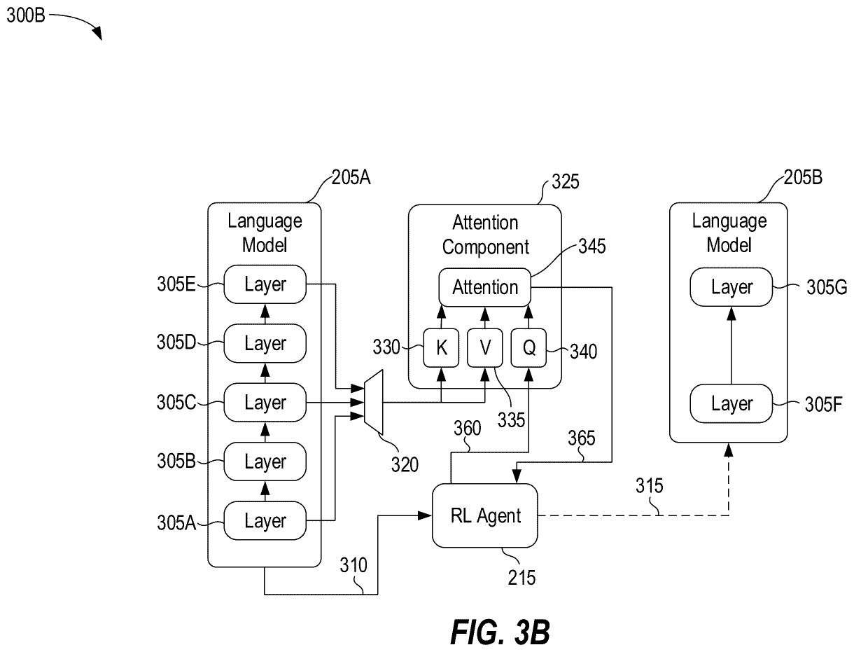

FIG. 3A depicts an example architecture 300A for attention-guided language generation, according to some aspects of the present disclosure. In some aspects, the architecture 300A is used by a machine learning system, such as the machine learning system 110 of FIG. 1 and/or the machine learning system discussed above with reference to FIG. 2.

In the illustrated example, a first language model 205A is used to generate a first token (e.g., a token 207 of FIG. 2) based on an input prompt. As indicated by the arrow 310, an output (e.g., the output 210 of FIG. 2) is provided to the RL agent 215 to select the next language model. As discussed above, the data processed by the RL agent 215 may generally include any data generated by the language model 205A, such as the selected token, the output probabilities, and the like. In some aspects, as discussed above, the RL agent 215 may further process other data such as the input prompt to select the next language model. In the illustrated example, as indicated by the dashed arrow 315, the RL agent 215 selects the language model 205B to generate the next token.

In the illustrated example, an attention component 325 is used to pass information from the current language model 205A to the next language model 205B. Specifically, in the illustrated example, the language model 205A includes a sequence of layers 305A-E which process the input data sequentially (e.g., where the output of the layer 305A is used as input to the layer 305B, and so on). Although depicted as a sequence of layers 305 for conceptual clarity, in some aspects, some or all of the layers 305 in the illustrated sequence may be implemented by processing the data using a single layer repeatedly.

In some aspects, the data output by a given layer 305 may be referred to as “intermediate features.” Generally, the intermediate features from any given layer 305 may comprise data (e.g., in the form of a tensor) that is undergoing processing by the language model 205A to generate an output token based on input (e.g., based on prior generated tokens and/or the input prompt). The intermediate features may generally be generated using any machine learning model operation of any layer 305, such as a transformer, a feedforward component (e.g., a multilayer perceptron), an activation function, and the like.

In the illustrated example, the intermediate features from one or more layers 305 (e.g., from the layers 305A, 305C, and 305E) are processed using an operation 320 and passed to the attention component 325. The operation 320 can generally correspond to any operation (or sequence of operations) used to aggregate the features. For example, the operation 320 may correspond to concatenating the intermediate features from the one or more layers 305, or otherwise linearly combining the features. Although the illustrated example depicts accessing intermediate feature data from the layers 305A, 305C, and 305E, the attention component 325 may generally use intermediate features from any number and combination of layers 305 depending on the particular implementation. In some aspects, using intermediate features from a larger number of layers 305 may result in improved model output, but may incur additional computational expense.

As illustrated, the combined or aggregated intermediate features are then processed using learned parameters to generate a set of keys 330 (referred to in some aspects as a “key tensor”) and a set of values 335 (referred to in some aspects as a “value tensor”). For example, the aggregated intermediate features may be multiplied with a few set of weight(s) to generate the keys 330 and a second set of weight(s) to generate the values 335. Generally, the weights used by the attention component 325 may be learned (e.g., while training the RL agent 215 to select from a set of frozen or static language models 205).

Further, in the illustrated architecture 300A, a set of intermediate features from the layer 305F of the language model 205B (which is selected to provide the next output token) are provided, via the arrow 350, to generate the queries 340 of the attention component 325. For example, the queries 340 (referred to in some aspects as the “query tensor”) may be generated using learned parameters of the attention component 325 (e.g., multiplying the features from the layer 305F using a set of learned weights).

As illustrated, the keys 330, values 335, and queries 340 are then processed by an attention operation 345 to generate an attention output (referred to as an “attention tensor” in some aspects). For example, in some aspects, the attention tensor may be defined as

$$softmax ( \frac{{QK}^{T}}{\sqrt{{d}_{k}}} ) V ,$$

where Q is the queries 340, K^{T} is the transposed keys 330, V is the values 335, and dₖ is the dimensionality of the keys 330. Though not depicted in the illustrated example, in some aspects, the attention component 325 may use masked attention or other operations.

In the illustrated example, as depicted by the arrow 355, the attention tensor is then provided to the layer 305G of the language model 205B, which also receives the intermediate features from the layer 305F. Generally, the attention tensor may be used by the layer 305G in any suitable way. For example, the attention tensor may be elementwise summed with the intermediate features from the layer 305F, and this aggregated data may then be processed by the layer 305G. In some aspects, the attention tensor may generally be added or combined with the intermediate features in the language model 205B as a residual.

Advantageously, by allowing queries 340 from the language model 205B to cross-attend to the keys 330 and values 335 from the language model 205A, the “plan of writing” can effectively be passed between the language models 205B (e.g., providing the language model 205B with additional insight about how the language model 205A was processing the data). This may result in substantially improved (e.g., more consistent) model output, in some aspects.

Turning now to FIG. 3B, an example architecture 300B for attention-guided language model selection, according to some aspects of the present disclosure, is depicted. In some aspects, the architecture 300B is used by a machine learning system, such as the machine learning system 110 of FIG. 1 and/or the machine learning system discussed above with reference to FIGS. 2 and/or 3A.

In the illustrated architecture 300B, the first language model 205A is used to generate the first token (e.g., a token 207 of FIG. 2) based on an input prompt. As indicated by the arrow 310, an output (e.g., the output 210 of FIG. 2) is provided to the RL agent 215 to select the next language model. As discussed above, the data processed by the RL agent 215 may generally include any data generated by the language model 205A, such as the selected token, the output probabilities, and the like. In some aspects, as discussed above, the RL agent 215 may further process other data such as the input prompt to select the next language model.

In the illustrated example, the attention component 325 is used to pass information from the current language model 205A to the RL agent 215 to facilitate the model selection process. Specifically, in the illustrated example, the language model 205A includes the sequence of layers 305A-E which process the input data sequentially (e.g., where the output of the layer 305A is used as input to the layer 305B, and so on). Although depicted as a sequence of layers 305 for conceptual clarity, in some aspects, some or all of the layers 305 in the illustrated sequence may be implemented by processing the data using a single layer repeatedly.

As illustrated, the intermediate features from one or more layers 305 (e.g., from the layers 305A, 305C, and 305E) are processed using the operation 320 and passed to the attention component 325. As discussed above, the operation 320 can generally correspond to any operation (or sequence of operations) used to aggregate the features. For example, the operation 320 may correspond to concatenating the intermediate features from the one or more layers 305, or otherwise linearly combining the features. Further, as discussed above, although the illustrated example depicts accessing intermediate feature data from the layers 305A, 305C, and 305E, the attention component 325 may generally use intermediate features from any number and combination of layers 305 depending on the particular implementation. In some aspects, using intermediate features from a larger number of layers 305 may result in improved model output, but may incur additional computational expense.

As illustrated, the combined or aggregated intermediate features are then processed using learned parameters to generate a set of keys 330 and a set of values 335, as discussed above. Generally, the parameters used by the attention component 325 may be learned (e.g., while training the RL agent 215 to select from a set of frozen or static language models 205).

Further, in the illustrated architecture 300B, a set of intermediate features from the RL agent 215 is provided, via the arrow 360, to generate the queries 340 of the attention component 325. For example, the queries 340 may be generated using learned parameters of the attention component 325 (e.g., multiplying the features from the RL agent 215 using a set of learned weights).

As illustrated, the keys 330, values 335, and queries 340 are then processed by an attention operation 345 to generate an attention output (referred to as an “attention tensor” in some aspects), as discussed above. In the illustrated example, as depicted by the arrow 365, the attention tensor is then provided back to the RL agent 215. Generally, the attention tensor may be used by the RL agent 215 in any suitable way. For example, the attention tensor may be elementwise summed with intermediate features from the RL agent 215. In some aspects, the attention tensor may generally be added or combined with the intermediate features in the RL agent 215 as a residual.

In the illustrated example, as indicated by the dashed arrow 315, the RL agent 215 selects the language model 205B to generate the next token (based at least in part on the intermediate features from the language model 205A, as processed by the attention component 325).

Advantageously, by allowing queries 340 from the RL agent 215 to cross-attend to the keys 330 and values 335 from the language model 205A, the “plan of writing” can effectively be passed to the RL agent 215 (e.g., providing the RL agent 215 with additional insight about how the language model 205A was processing the data). This may result in substantially improved (e.g., more consistent) selection of the subsequent language model 205B, in some aspects.

In some aspects, the architecture 300A of FIG. 3A and the architecture 300B of FIG. 3B may be combined. For example, an attention component may be used to provide cross-attention between one or more prior language models 205 and the RL agent 215 to improve the selection of the next model, and one or more other attention components may also be used to provide cross-attention between the one or more language models 205 and the next-selected language model 205 to improve the quality and consistency of the generated outputs.

### Example Method for Dynamic Language Model Selection and Generative Machine Learning

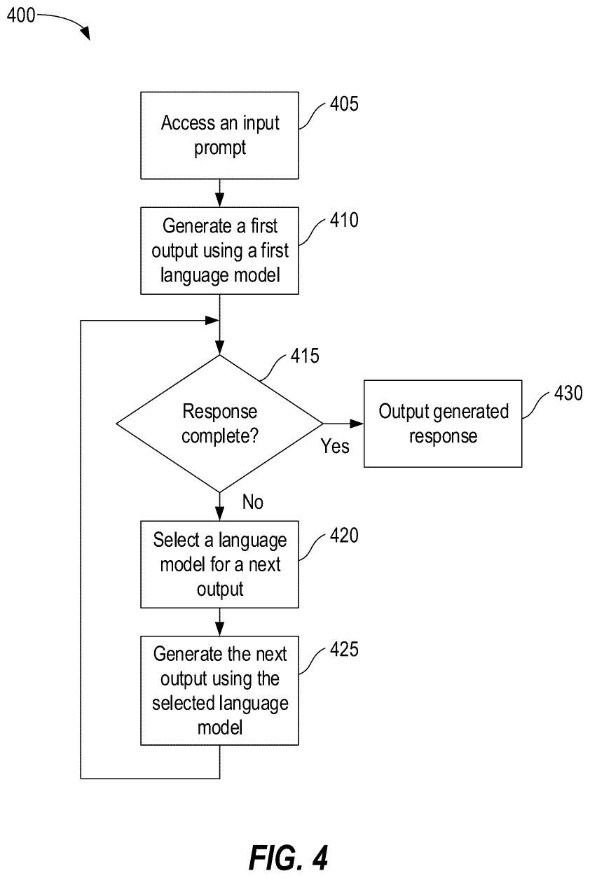

FIG. 4 is a flow diagram depicting an example method 400 for dynamic language model selection and generative machine learning, according to some aspects of the present disclosure. In some aspects, the method 400 is performed by a machine learning system, such as the machine learning system 110 of FIG. 1 and/or the machine learning system discussed above with reference to FIGS. 2, 3A, and/or 3B.

At block 405, the machine learning system accesses an input prompt (e.g., the input prompt 105 of FIG. 1). Generally, as discussed above, the input prompt may comprise a set of tokens. For example, in some aspects, the input prompt comprises a sequence of words in natural language.

At block 410, the machine learning system generates a first output using a first language model based on the input prompt. For example, the machine learning system may generate a first token (e.g., the token 207A of FIG. 2) based on processing the input prompt using the first language model (e.g., the language model 205A of FIG. 2). In some aspects, the machine learning system selects the first language model using a trained RL agent, as discussed above (e.g., by processing the prompt using the agent). In some aspects, the first token in the sequence (before other tokens are generated) may be selected based a defined mapping or hyperparameter (e.g., generating the first token in the sequence using a defined model, such as the largest LLM, and then using the agent to select the model for each subsequent token).

At block 415, the machine learning system determines whether the generated response is complete. Generally, the machine learning system may use a variety of criteria to determine whether the response is complete. For example, the machine learning system may determine whether the generated output has a defined number of tokens (e.g., based on a maximum response length hyperparameter), whether the most recently generated token is an “end” token signaling the end of the response generation process, and the like.

If, at block 415, the machine learning system determines that the response is complete, the method 400 continues to block 430 where the machine learning system outputs or returns the generated response (e.g., the sequence of tokens generated using the model(s)). For example, the machine learning system may transmit the response to the entity that provided the input prompt, may output the response via a display or other component, and the like.

Returning to block 415, if the machine learning system determines that the response is not complete, the method 400 continues to block 420. At block 420, the machine learning system selects a next language model to be used to generate the next output token of the response. In some aspects, as discussed above, the machine learning system may select the next language model using an agent trained using reinforcement learning (e.g., the RL agent 215 of FIG. 2).

Generally, the RL agent may process a variety of data to select the next language model. For example, in some aspects, the machine learning system may process the most recently generated token in the response, a sequence of response tokens (e.g., the previous N tokens, or all tokens generated thus far for the input prompt), and the like. In some aspects, in addition to or instead of evaluating the tokens themselves, the machine learning system may process the output probabilities generated by one or more language model(s) during one or more prior iterations to generate one or more prior tokens.

In some aspects, the RL agent may additionally or alternatively evaluate information such as the intermediate features generated by one or more language models while generating one or more prior tokens in the response. For example, as discussed above, the machine learning system may cross-attend to these features using an attention mechanism (e.g., the attention component 325 of FIG. 3B).

In some aspects, the RL agent may additionally or alternatively evaluate information such as the identity of the language model that generated the previous token and/or the sequence of language models that generated multiple prior tokens. For example, this may allow the RL agent to reduce the number of model switches, to enforce a decreasing computational complexity constraint on the selection, and the like.

At block 425, the machine learning system generates the next output token for the response using the selected language model. For example, as discussed above, the machine learning system may process the previous token using the selected language model. In some aspects, the selected language model may process a variety of data to generate the next output token. For example, in some aspects, the machine learning system may process the most recently generated token in the response, a sequence of response tokens (e.g., the previous N tokens, or all tokens generated thus far for the input prompt), and the like. In some aspects, in addition to or instead of evaluating the tokens themselves, the machine learning system may process the output probabilities generated by one or more language model(s) during one or more prior iterations to generate one or more prior tokens.

In some aspects, the language model may additionally or alternatively evaluate information such as the intermediate features generated by one or more language models while generating one or more prior tokens in the response. For example, as discussed above, the machine learning system may cross-attend to these features using an attention mechanism (e.g., the attention component 325 of FIG. 3A).

The method 400 then returns to block 415. In this way, the machine learning system can iteratively generate output tokens and dynamically select which language model to use for each output token using a trained RL agent that can significantly reduce computational expense and/or improve (or at least maintain) the generation accuracy.

### Example Method for Generative Machine Learning

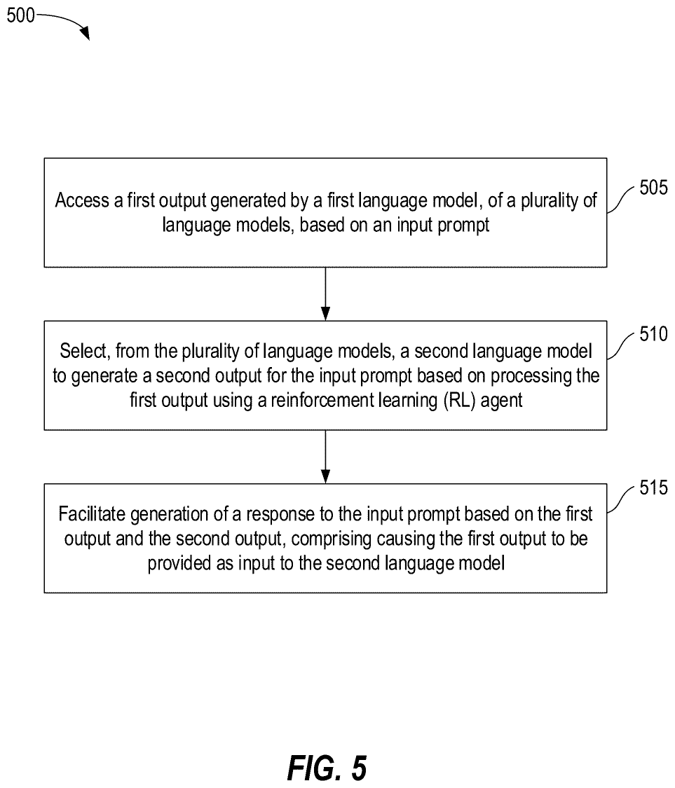

FIG. 5 is a flow diagram depicting an example method 500 for generative machine learning, according to some aspects of the present disclosure. In some aspects, the method 500 is performed by a machine learning system, such as the machine learning system 110 of FIG. 1 and/or the machine learning system discussed above with reference to FIGS. 2, 3A, 3B, and/or 4.

At block 505, a first output generated by a first language model, of a plurality of language models, based on an input prompt is accessed.

At block 510, a second language model, selecting, from the plurality of language models, is selected to generate a second output for the input prompt based on processing the first output using a reinforcement learning (RL) agent.

At block 515, generation of a response to the input prompt is facilitated based on the first output and the second output, comprising causing the first output to be provided as input to the second language model.

In some aspects, the first output comprises a set of output probabilities for each token of a set of tokens.

In some aspects, the method 500 further includes accessing a set of intermediate features from the first language model, wherein selecting the second language model is based further on the set of intermediate features.

In some aspects, selecting the second language model comprises generating an attention tensor based at least in part on the set of intermediate features and selecting the second language model based at least in part on the attention tensor.

In some aspects, facilitating generation of the response further comprises causing a set of intermediate features from the first language model to be provided to the second language model.

In some aspects, the method 500 further includes accessing a third output generated prior to the first output based on the input prompt, wherein selecting the second language model is based further on processing the third output using the RL agent.

In some aspects, facilitating generation of the response further comprises causing the third output to be provided to the second language model.

In some aspects, the RL agent was trained to select language models, from the plurality of language models, based on reducing computational expense of generating responses to input prompts.

In some aspects, the RL agent was trained to select language models, from the plurality of language models, based on model prediction accuracy.

In some aspects, the RL agent was trained to select language models, from the plurality of language models, based on reducing language model switches when generating consecutive output tokens.

In some aspects, the RL agent was trained to select language models, from the plurality of language models, of equal or less computational expense for each subsequent output token.

In some aspects, the second language model corresponds to at least one of: (i) a truncated version of the first language model, (ii) a model having fewer parameters, as compared to the first language model, or (iii) a first finetuned version of a base machine learning model, wherein the first language model corresponds to a second finetuned version of the base machine learning model.

### Example Processing System for Generative Machine Learning

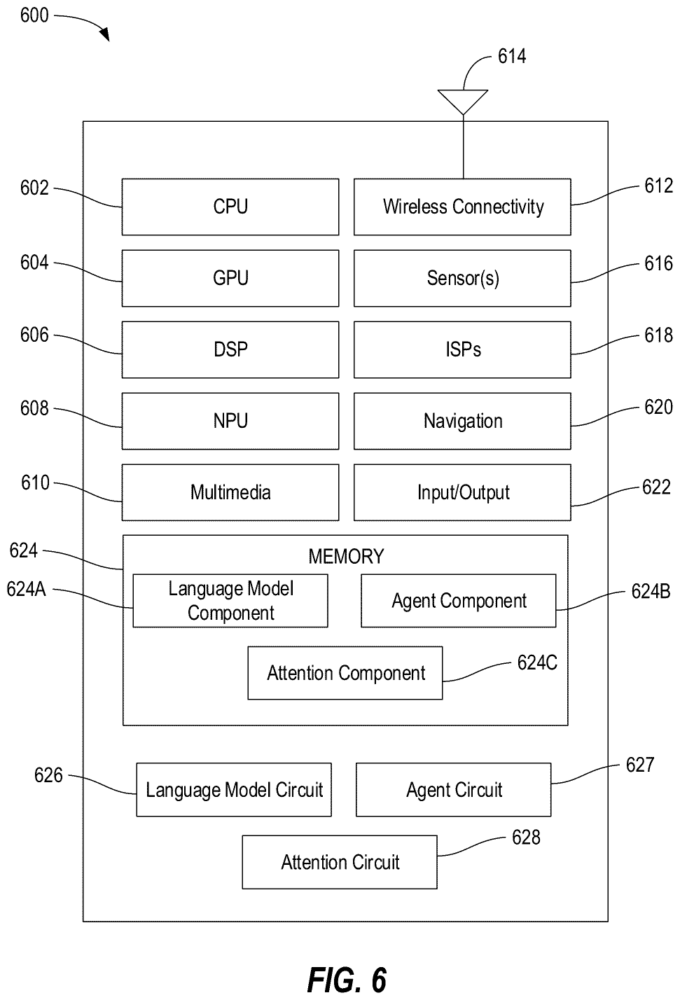

FIG. 6 depicts an example processing system 600 configured to perform various aspects of the present disclosure, including, for example, the techniques and methods described with respect to FIGS. 1-5. In some aspects, the processing system 600 may correspond to a machine learning system. For example, the processing system 600 may correspond to the machine learning system 110 of FIG. 1 and/or the machine learning system discussed above with reference to FIGS. 2, 3A, 3B, 4, and/or 5. Although depicted as a single system for conceptual clarity, in some aspects, as discussed above, the components described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a language model component 624A, an agent component 624B, and an attention component 624C. Although not depicted in the illustrated example, the memory 624 may also include other components, such as an inferencing or generation component to manage the generation of output data using generative machine learning models (e.g., language models), a training component used to train or update the generative machine learning model(s), and the like. Though depicted as discrete components for conceptual clarity in FIG. 6, the illustrated components (and others not depicted) may be collectively or individually implemented in various aspects.

Further, although not depicted in the illustrated example, the memory 624 may also include various data, such as a set of model parameters (e.g., parameters of one or more language models), training data, and the like.

The processing system 600 further comprises a language model circuit 626, an agent circuit 627, and an attention circuit 628. The depicted circuits, and others not depicted (such as an inferencing circuit), may be configured to perform various aspects of the techniques described herein.

The language model component 624A and/or the language model circuit 626 (which may correspond to the language model component 120 of FIG. 1 and/or the language model(s) 205 of FIGS. 2, 3A, and/or 3B) may be used to generate output tokens (e.g., the tokens 207 of FIG. 2), as discussed above. For example, the language model component 624A and/or the language model circuit 626 may process data such as the input prompt, the previously generated tokens (if any), intermediate features corresponding to one or more previous tokens, and the like.

The agent component 624B and/or the agent circuit 627 (which may correspond to the agent component 125 of FIG. 1 and/or the RL agent 215 of FIGS. 2, 3A, and/or 3B) may be used to select, for each token in the output response, which language model should generate the token, as discussed above. For example, the agent component 624B and/or the agent circuit 627 may use reinforcement learning to select which language model to use for each token based on may processing data such as the input prompt, the previously generated tokens (if any), intermediate features corresponding to one or more previous tokens, the language model(s) used to generate one or more prior tokens, and the like.

The attention component 624C and/or the attention circuit 628 (which may correspond to the attention component 325 of FIGS. 3A and/or 3B) may be used to generate attention outputs to cross-attend between language models and/or between language models and the RL agent, as discussed above. For example, the attention component 624C and/or the attention circuit 628 may generate a set of keys and/or values based on the intermediate features generated by one or more language models when generating output tokens. The attention component 624C and/or the attention circuit 628 may similarly generate the queries based on intermediate features of the currently selected language model and/or the RL agent in order to generate attention. This attention may be fed back into the current language model and/or the RL agent (e.g., as a residual) to guide the generation and/or selection process.

Though depicted as separate components and circuits for clarity in FIG. 6, the language model circuit 626, the agent circuit 627, and the attention circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 maybe distributed between multiple devices.

### Example Clauses

Implementation examples are described in the following numbered clauses:

Clause 1: A method, comprising: accessing a first output generated by a first language model, of a plurality of language models, based on an input prompt; selecting, from the plurality of language models, a second language model to generate a second output for the input prompt based on processing the first output using a reinforcement learning (RL) agent; and facilitating generation of a response to the input prompt based on the first output and the second output, comprising causing the first output to be provided as input to the second language model.

Clause 2: A method according to Clause 1, wherein the first output comprises a set of output probabilities for each token of a set of tokens.

Clause 3: A method according to any of Clauses 1-2, further comprising accessing a set of intermediate features from the first language model, wherein selecting the second language model is based further on the set of intermediate features.

Clause 4: A method according to Clause 3, wherein selecting the second language model comprises: generating an attention tensor based at least in part on the set of intermediate features; and selecting the second language model based at least in part on the attention tensor.

Clause 5: A method according to any of Clauses 1-4, wherein facilitating generation of the response further comprises causing a set of intermediate features from the first language model to be provided to the second language model.

Clause 6: A method according to any of Clauses 1-5, further comprising accessing a third output generated prior to the first output based on the input prompt, wherein selecting the second language model is based further on processing the third output using the RL agent.

Clause 7: A method according to Clause 6, wherein facilitating generation of the response further comprises causing the third output to be provided to the second language model.

Clause 8: A method according to any of Clauses 1-7, wherein the RL agent was trained to select language models, from the plurality of language models, based on reducing computational expense of generating responses to input prompts.

Clause 9: A method according to any of Clauses 1-8, wherein the RL agent was trained to select language models, from the plurality of language models, based on model prediction accuracy.

Clause 10: A method according to any of Clauses 1-9, wherein the RL agent was trained to select language models, from the plurality of language models, based on reducing language model switches when generating consecutive output tokens.

Clause 11: A method according to any of Clauses 1-10, wherein the RL agent was trained to select language models, from the plurality of language models, of equal or less computational expense for each subsequent output token.

Clause 12: A method according to any of Clauses 1-11, wherein the second language model corresponds to at least one of: (i) a truncated version of the first language model, (ii) a model having fewer parameters, as compared to the first language model, or (iii) a first finetuned version of a base machine learning model, wherein the first language model corresponds to a second finetuned version of the base machine learning model.

Clause 13: A processing system comprising: a memory comprising processor-executable instructions; and one or more processors coupled to the one or more memories and configured to execute the processor-executable instructions and cause the processing system to perform a method in accordance with any of Clauses 1-12.

Clause 14: A processing system comprising means for performing a method in accordance with any of Clauses 1-12.

Clause 15: A non-transitory computer-readable medium comprising computer-executable instructions that, when executed by one or more processors of a processing system, cause the processing system to perform a method in accordance with any of Clauses 1-12.

Clause 16: A computer program product embodied on a computer-readable storage medium comprising code for performing a method in accordance with any of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
access a first output generated by a first language model, of a plurality of language models, based on an input prompt;
select, from the plurality of language models, a second language model to generate a second output for the input prompt based on processing the first output using a reinforcement learning (RL) agent; and
facilitate generation of a response to the input prompt based on the first output and the second output, comprising causing the first output to be provided as input to the second language model.

2. The processing system of claim 1, wherein the first output comprises a set of output probabilities for each token of a set of tokens.

3. The processing system of claim 1, wherein the one or more processors are configured to further execute the processor-executable instructions and cause the processing system to access a set of intermediate features from the first language model, wherein the second language model is selected based further on the set of intermediate features.

4. The processing system of claim 3, wherein, to select the second language model, the one or more processors are configured to execute the processor-executable instructions and cause the processing system to:
generate an attention tensor based at least in part on the set of intermediate features; and
select the second language model based at least in part on the attention tensor.

5. The processing system of claim 1, wherein, to facilitate generation of the response, the one or more processors are configured to further execute the processor-executable instructions and cause the processing system to cause a set of intermediate features from the first language model to be provided to the second language model.

6. The processing system of claim 1, wherein the one or more processors are configured to further execute the processor-executable instructions and cause the processing system to access a third output generated prior to the first output based on the input prompt, wherein the second language model is selected based further on processing the third output using the RL agent.

7. The processing system of claim 6, wherein, to facilitate generation of the response, the one or more processors are configured to further execute the processor-executable instructions and cause the processing system to cause the third output to be provided to the second language model.

8. The processing system of claim 1, wherein the RL agent was trained to select language models, from the plurality of language models, based on reducing computational expense of generating responses to input prompts.

9. The processing system of claim 1, wherein the RL agent was trained to select language models, from the plurality of language models, based on model prediction accuracy.

10. The processing system of claim 1, wherein the RL agent was trained to select language models, from the plurality of language models, based on reducing language model switches when generating consecutive output tokens.

11. The processing system of claim 1, wherein the RL agent was trained to select language models, from the plurality of language models, of equal or less computational expense for each subsequent output token.

12. The processing system of claim 1, wherein the second language model corresponds to at least one of:
(i) a truncated version of the first language model,
(ii) a model having fewer parameters, as compared to the first language model, or
(iii) a first finetuned version of a base machine learning model, wherein the first language model corresponds to a second finetuned version of the base machine learning model.

13. A processor-implemented method of machine learning, comprising:
accessing a first output generated by a first language model, of a plurality of language models, based on an input prompt;
selecting, from the plurality of language models, a second language model to generate a second output for the input prompt based on processing the first output using a reinforcement learning (RL) agent; and
facilitating generation of a response to the input prompt based on the first output and the second output, comprising causing the first output to be provided as input to the second language model.

14. The processor-implemented method of claim 13, wherein the first output comprises a set of output probabilities for each token of a set of tokens.

15. The processor-implemented method of claim 13, further comprising accessing a set of intermediate features from the first language model, wherein selecting the second language model is based further on the set of intermediate features.

16. The processor-implemented method of claim 15, wherein selecting the second language model comprises:
generating an attention tensor based at least in part on the set of intermediate features; and
selecting the second language model based at least in part on the attention tensor.

17. The processor-implemented method of claim 13, wherein facilitating generation of the response further comprises causing a set of intermediate features from the first language model to be provided to the second language model.

18. The processor-implemented method of claim 13, further comprising accessing a third output generated prior to the first output based on the input prompt, wherein selecting the second language model is based further on processing the third output using the RL agent.

19. The processor-implemented method of claim 18, wherein facilitating generation of the response further comprises causing the third output to be provided to the second language model.

20. A processing system comprising:
means for accessing a first output generated by a first language model, of a plurality of language models, based on an input prompt;
means for selecting, from the plurality of language models, a second language model to generate a second output for the input prompt based on processing the first output using a reinforcement learning (RL) agent; and
means for facilitating generation of a response to the input prompt based on the first output and the second output, comprising causing the first output to be provided as input to the second language model.
